(19) United States
(12) Patent Application Publication
(10) Pub. No.: US 2024/0227266 A9
(43) Pub. Date: Jul. 11, 2024

(54) Reinforcement Learning Method, Non-Transitory Computer Readable Recording Medium, Reinforcement Learning Device and Molding Machine

(71) Applicant: THE JAPAN STEEL WORKS, LTD., Tokyo (JP)

(72) Inventor: Takayuki Hirano, Tokyo (JP)

(21) Appl. No.: 18/279,166

(22) PCT Filed: Mar. 17, 2022
(86) PCT No.: PCT/JP2022/012203

§ 371 Date: Aug. 28, 2023

(30) Foreign Application Priority Data
Mar. 18, 2021 (JP) 2021-044999

(51) Int. Cl. B29C 45/76

(52) U.S. Cl. CPC B29C 45/76; B29C 2945/76979

(57) ABSTRACT

A reinforcement learning method of a learning machine including a first agent adjusting a manufacture condition of a manufacturing device based on observation data obtained by observing a state of the manufacturing device and a second agent having a functional model or a functional approximator representing a relationship between the observation data and the manufacture condition in a different way from the first agent, comprises: adjusting the manufacture condition searched by the first agent that is performing reinforcement learning, using the observation data and the functional model or the functional approximator of the second agent; calculating reward data in accordance with a state of a product manufactured by the manufacturing device under the manufacture condition adjusted; and performing reinforcement learning on the first agent and the second agent based on the observation data and the reward data calculated.

### CROSS-REFERENCE TO RELATED APPLICATIONS

This application is the national phase under 35 U. S. C. § 371 of PCT International Application No. PCT/JP2022/012203 which has an International filing date of Mar. 17, 2022 and designated the United States of America.

### BACKGROUND ART

The present disclosure relates to a reinforcement learning method, a computer program, a reinforcement learning device and a molding machine.

There is provided an injection molding machine system capable of appropriately adjusting a molding condition of an injection molding machine using reinforcement learning (Japanese Patent Application Laid-Open No. 2019-166702, for example).

### DESCRIPTION

Searching for a molding condition using reinforcement learning, however, causes setting of an inappropriate molding condition as an action, so that an abnormal operation of the injection molding machine may produce an unexpected disadvantage to the molding machine and the operator. Such a problem commonly occurs in manufacturing devices.

An object of the present disclosure is to provide a reinforcement learning method, a computer program, a reinforcement learning device and a molding machine that are capable of performing reinforcement learning on a learning machine while safely searching for an optimal manufacture condition without limiting a search range to a certain range in the reinforcement learning of a learning machine for adjusting the manufacture condition of a manufacturing device.

A reinforcement learning method according to the present aspect is a reinforcement learning method for a learning machine including a first agent adjusting a manufacture condition of a manufacturing device based on observation data obtained by observing a state of the manufacturing device and a second agent having a functional model or a functional approximator representing a relationship between the observation data and the manufacture condition in a different way from the first agent, and comprises: adjusting the manufacture condition searched by the first agent that is performing reinforcement learning, using the observation data and the functional model or the functional approximator of the second agent; calculating reward data in accordance with a state of a product manufactured by the manufacturing device under the manufacture condition adjusted; and performing reinforcement learning on the first agent and the second agent based on the observation data and the reward data calculated.

A computer program according to the present aspect is a computer program causing a computer to perform reinforcement learning on a learning machine including a first agent adjusting a manufacture condition of a manufacturing device based on observation data obtained by observing a state of the manufacturing device and a second agent having a functional model or a functional approximator representing a relationship between the observation data and the manufacture condition in a different way from the first agent, the computer program causing the computer to execute processing of adjusting the manufacture condition searched by the first agent that is performing reinforcement learning, using the observation data and the functional model or the functional approximator of the second agent; calculating reward data in accordance with a state of a product manufactured by the manufacturing device under the manufacture condition adjusted; and performing reinforcement learning on the first agent and the second agent based on the observation data and the reward data calculated.

A reinforcement learning device according to the present aspect is a reinforcement learning device performing reinforcement learning on a learning machine adjusting a manufacture condition of a manufacturing device based on observation data obtained by observing a state of the manufacturing device, and the learning machine comprises a first agent that adjusts the manufacture condition of the manufacturing device based on the observation data; a second agent that has a functional model or a functional approximator representing a relationship between the observation data and the manufacture condition in a different way from the first agent; an adjustment unit that adjusts the manufacture condition searched by the first agent that is performing reinforcement learning, using the observation data and the functional model or the functional approximator of the second agent; and a reward calculation unit that calculates reward data in accordance with a state of a product manufactured by the manufacturing device under the manufacture condition adjusted, the learning machine performing reinforcement learning on the first agent and the second agent based on the observation data and the reward data calculated by the reward calculation unit.

A molding machine according to the present aspect comprises the above-mentioned reinforcement learning device, and a manufacturing device operated using the manufacture condition adjusted by the first agent.

According to the present disclosure, it is possible to perform reinforcement learning on a learning machine while safely searching for an optimal manufacture condition without limiting a search range to a certain range in the reinforcement learning of a learning machine for adjusting the manufacture condition of a manufacturing device.

The above and further objects and features will more fully be apparent from the following detailed description with accompanying drawings.

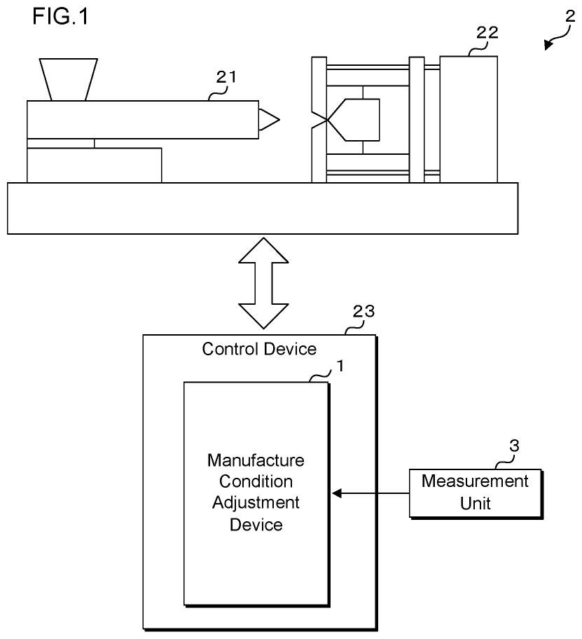

FIG. 1 is a schematic view illustrating an example of the configuration of a molding machine system according to a first embodiment.

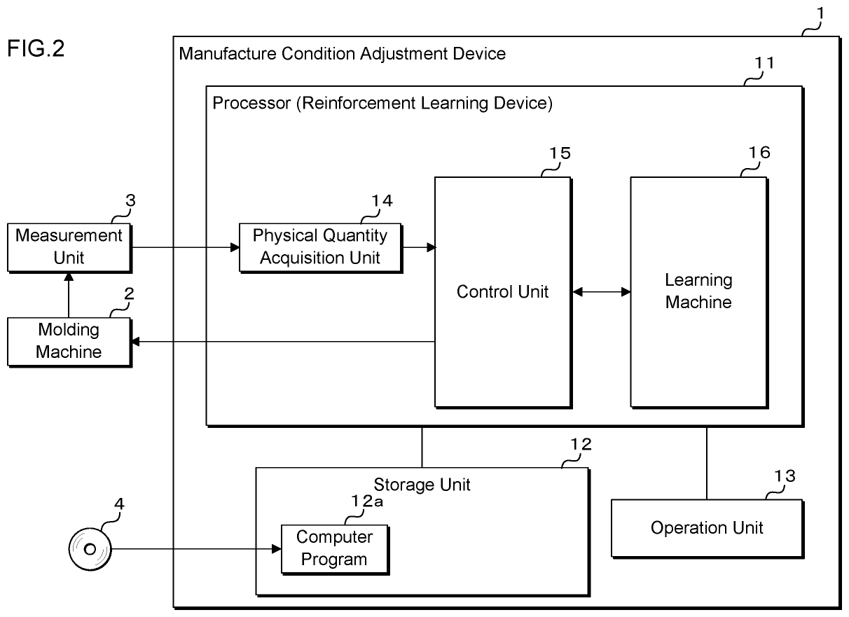

FIG. 2 is a block diagram illustrating an example of the configuration of the molding machine system according to the first embodiment.

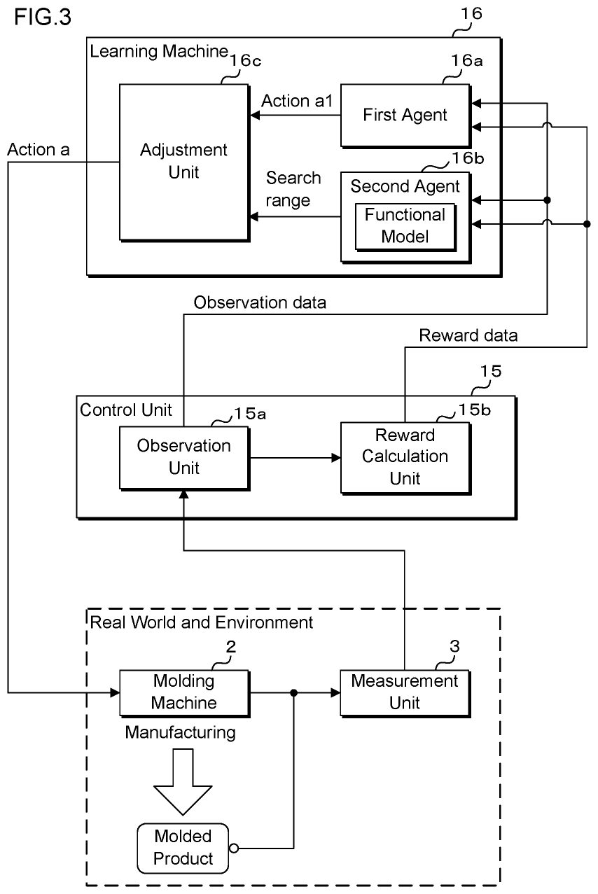

FIG. 3 is a functional block diagram of the molding machine system according to the first embodiment.

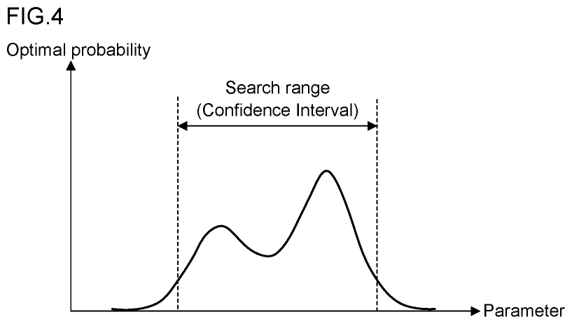

FIG. 4 is a conceptual diagram illustrating a functional model and a search range.

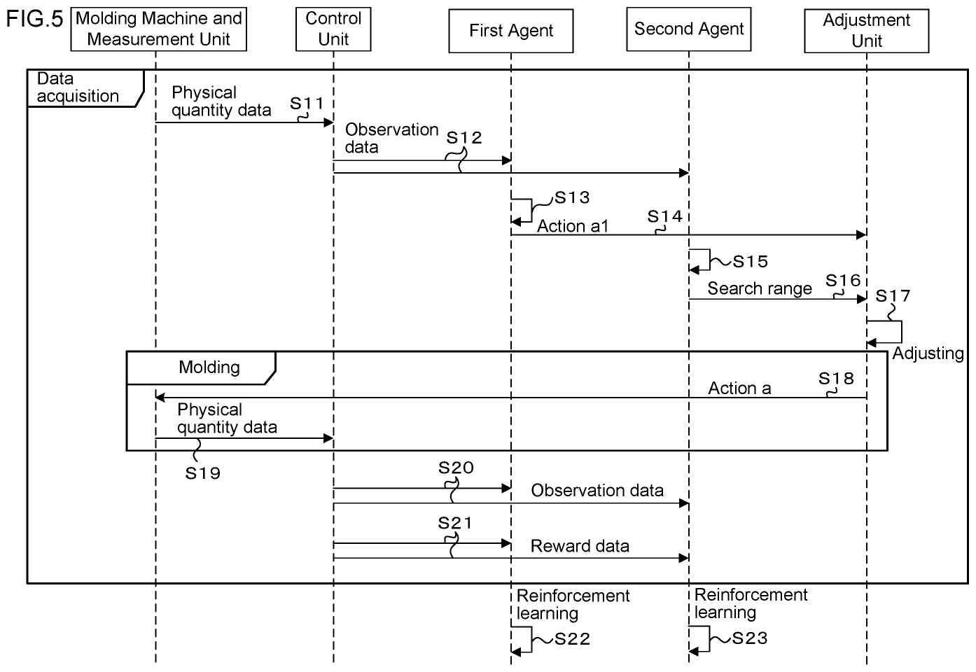

FIG. 5 is a flowchart illustrating a processing procedure executed by a processor.

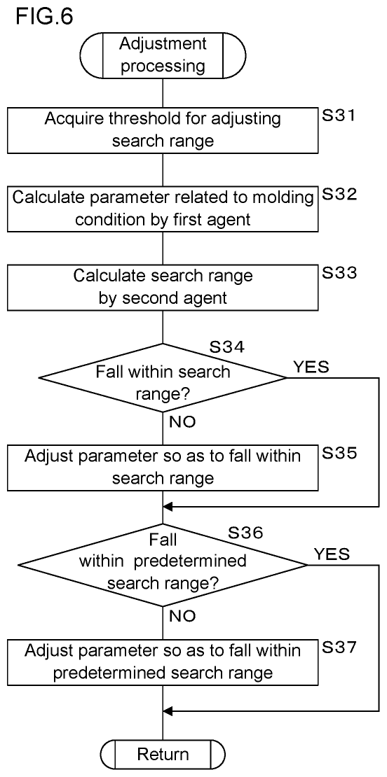

FIG. 6 is a flowchart illustrating a processing procedure for adjusting a search range according to a second embodiment.

Specific examples of a reinforcement learning method, a computer program, a reinforcement learning device and a manufacturing device according to embodiments of the present disclosure will be described below with reference to the drawings. Furthermore, at least parts of the following embodiments and modification may arbitrarily be combined. It should be noted that the invention is not limited to these examples, is indicated by the scope of claims, and is intended to include all modifications within the meaning and scope equivalent to the scope of claims.

FIG. 1 is a schematic view illustrating an example of the configuration of a molding machine system according to a first embodiment. FIG. 2 is a block diagram illustrating an example of the configuration of the molding machine system according to the first embodiment. FIG. 3 is a functional block diagram of the molding machine system according to the first embodiment. The molding machine system according to the first embodiment includes a molding machine (manufacturing device) 2 having a manufacture condition adjustment device 1, and a measurement unit 3.

Examples of the molding machine 2 include an injection molding machine, a blow molding machine, a film forming machine, an extruder, a twin-screw extruder, a spinning extruder, a pelletizing machine, a magnesium injection molding machine and the like. In the first embodiment, a description will be given below on the assumption that the molding machine 2 is an injection molding machine. The molding machine 2 has an injection device 21, a mold clamping device 22 disposed in front of the injection device 21 and a control device 23 for controlling the operation of the molding machine 2.

The injection device 21 is composed of a heating cylinder, a screw that may be driven in a rotational direction and an axial direction in the heating cylinder, a rotary motor that drives the screw in the rotational direction, a motor that drives the screw in the axial direction and the like.

The mold clamping device 22 has a toggle mechanism that tightens a mold so that the mold does not open when a molten resin injected from the injection device 21 fills the mold by opening or closing the mold, and a motor that drives the toggle mechanism.

The control device 23 controls the operation of the injection device 21 and the mold clamping device 22. The control device 23 according to the first embodiment has the manufacture condition adjustment device 1. The manufacture condition adjustment device 1 is a device for adjusting multiple parameters related to molding conditions of the molding machine 2. The manufacture condition adjustment device 1 according to the first embodiment especially has a function of adjusting a parameter so as to reduce the defect degree of a molded product.

A parameter for setting a molding condition is set to the molding machine 2, including an in-mold resin temperature, a nozzle temperature, a cylinder temperature, a hopper temperature, a mold clamping force, an injection speed, an injection acceleration, an injection peak pressure, an injection stroke, a cylinder-tip resin pressure, a reverse flow preventive ring seating state, a holding pressure switching pressure, a holding pressure switching speed, a holding pressure switching position, a holding pressure completion position, a cushion position, a metering back pressure, a metering torque, a metering completion position, a screw retreat speed, a cycle time, a mold closing time, an injection time, a pressure holding time, a metering time, a mold opening time and the like. The molding machine 2 is operated according to these parameters. An optimum parameter varies in accordance with the environment of the molding machine 2 and the molded product.

The measurement unit 3 is a device that measures a physical quantity related to actual molding when molding by the molding machine 2 is executed. The measurement unit 3 outputs physical quantity data obtained by the measurement process to the manufacture condition adjustment device 1. Examples of the physical quantity include temperature, position, speed, acceleration, current, voltage, pressure, time, image data, torque, force, strain, power consumption and the like.

The information measured by the measurement unit 3 includes, for example, molded product information, a molding condition (measurement value), a peripheral device setting value (measurement value), atmosphere information and the like. The peripheral device is a device included in a system linked with the molding machine 2, and includes the mold clamping device 22 and a mold. Examples of the peripheral device include a molded product take-out device (robot), an insert product insertion device, a nesting insertion device, an in-mold molding foil feeder, a hoop feeder for hoop molding, a gas injection device for gas assist molding, a gas injection device or a long fiber injection device for foam molding using supercritical fluid, a material mixing device for LIM molding, a molded product deburring device, a runner cutting device, a molded product metering scale, a molded product strength tester, an optical inspection device for molded products, a molded product photographing device and image processing device, a molded product transporting robot and the like.

The molded product information includes, for example, information such as a camera image obtained by photographing a molded product, a deformation amount of the molded product obtained by a laser displacement sensor, an optically measured value such as luminance, chromaticity and the like of the molded product obtained by an optical measurement instrument, a weight of the molded product measured by a weighing scale, strength of the molded product measured by a strength measurement instrument and the like. The molded product information expresses whether or not the molded product is normal, its defect type and its defect degree, and is also used for calculating a reward.

The molding condition includes information such as an in-mold resin temperature, a nozzle temperature, a cylinder temperature, a hopper temperature, a mold clamping force, an injection speed, an injection acceleration, an injection peak pressure, an injection stroke, a cylinder tip resin pressure, a reverse protection ring seating state, a holding pressure switching pressure, a holding pressure switching speed, a holding pressure switching position, a holding pressure completion position, a cushion position, a metering back pressure, metering torque, a metering completion position, a screw retreat speed, a cycle time, a mold closing time, an injection time, a pressure holding time, a metering time, a mold opening time and the like measured and obtained using a thermometer, a pressure gauge, a speed measurement instrument, an acceleration measurement instrument, a position sensor, a timer, a metering scale and the like.

The peripheral device setting value includes information such as a mold temperature set as a fixed value, a mold temperature set as a variable value and a pellet supply amount that are measured and obtained using a thermometer, a metering instrument and the like.

The atmosphere information includes information such as an atmosphere temperature, atmosphere humidity and information on convection (Reynolds number or the like) that are obtained using a thermometer, a hygrometer, a flow meter and the like.

In addition, the measurement unit 3 may measure a mold opening amount, a backflow amount, a tie bar deformation amount and a heating rate.

The manufacture condition adjustment device 1 is a computer and is provided with a processor 11 (reinforcement learning device), a storage unit (storage) 12, an operation unit 13 and the like as a hardware configuration as illustrated in FIG. 2. The processor 11 includes an arithmetic processing circuit such as a CPU (Central Processing Unit), a multi-core CPU, a GPU (Graphics Processing Unit), a General-purpose computing on graphics processing units (GPGPU), a Tensor Processing Unit (TPU), an Application Specific Integrated Circuit (ASIC), an Field-Programmable Gate Array (FPGA) and an Neural Processing Unit (NPU), an internal storage device such as a ROM (Read Only Memory) and a RAM (Random Access Memory), an I/O terminal and the like. The processor 11 functions as a physical quantity acquisition unit 14, a control unit 15 and a learning machine 16 by executing a computer program (program product) 12a stored in the storage unit 12, which will be described later. Note that each functional part of the manufacture condition adjustment device 1 may be realized in software, or some or all of the functional parts thereof may be realized in hardware.

The storage unit 12 is a nonvolatile memory such as a hard disk, an EEPROM (Electrically Erasable Programmable ROM), a flash memory or the like. The storage unit 12 stores the computer program 12a for causing the computer to execute reinforcement learning processing of the learning machine 16 and parameter adjustment processing.

The computer program 12a according to the first embodiment may be recorded on a recording medium 4 so as to be readable by the computer. The storage unit 12 stores the computer program 12a read by a reader (not illustrated) from the recording medium 4. The recording medium 4 is a semiconductor memory such as a flash memory. Furthermore, the recording medium 4 may be an optical disc such as a CD (Compact Disc)-ROM, a DVD (Digital Versatile Disc)-ROM, or a BD (Blu-ray (registered trademark) Disc). Moreover, the recording medium 4 may be a magnetic disk such as a flexible disk or a hard disk, or a magneto-optical disk. In addition, the computer program 12a according to the first embodiment may be downloaded from an external server (not illustrated) connected to a communication network (not illustrated) and may be stored in the storage unit 12.

The operation unit 13 is an input device such as a touch panel, a soft key, a hard key, a keyboard, a mouse or the like.

The physical quantity acquisition unit 14 acquires physical quantity data that is measured and output by the measurement unit 3 when molding by the molding machine 2 is executed. The physical quantity acquisition unit 14 outputs the acquired physical quantity data to the control unit 15.

As illustrated in FIG. 3, the control unit 15 has an observation unit 15a and a reward calculation unit 15b. The observation unit 15a receives an input of the physical quantity data output from the measurement unit 3.

The observation unit 15a observes the state of the molding machine 2 and the molded product by analyzing the physical quantity data, and outputs observation data obtained through observation to a first agent 16a and a second agent 16b of the learning machine 16. Since the information volume of the physical quantity data is high, the observation unit 15a may compress the information of the physical quantity data to generate observation data. The observation data is information indicating the state or the like of the molding machine 2 and a molded product.

For example, the observation unit 15a calculates observation data indicating a feature indicating an appearance characteristic of the molded product, the dimensions, area and volume of the molded product, an optical axis deviation amount of the optical component (molded product) and the like based on a camera image and a measurement value from the laser displacement sensor.

Furthermore, the observation unit 15a may execute preprocessing on time-series waveform data of the injection speed, injection pressure, holding pressure and the like and extract the feature of the time-series waveform data as observation data. Time-series data of a time-series waveform and image data representing the time-series waveform may be used as observation data.

Moreover, the observation unit 15a calculates a defect degree of the molded product by analyzing the physical quantity data and outputs the calculated defect degree to the reward calculation unit 15b. The defect degree is, for example, the area of burrs, the area of short, the amount of deformation such as sink marks, warp and twisting, the length of a weld line, the size of silver streak, a jetting degree, the size of a flow mark, the amount of color change due to inferior quality of color stability and the like. In addition, the defect degree may be a changed amount of the observation data obtained from the molding machine from the observation data which is a criterion for a good product.

The reward calculation unit 15b calculates reward data, which is a criterion for suitability of the parameter based on the defect degree output from the observation unit 15a, and outputs the calculated and obtained reward data to the first agent 16a and the second agent 16b of the learning machine 16.

As will be described later, in the case where the action a1 output from the first agent 16a falls out of a search range output from the second agent 16b, a minus reward may be added in accordance with the deviation degree. That is, a larger minus reward (which has a larger absolute value) may be added as the deviation degree increases for the action a1 output from the first agent 16a with respect to the search range output from the second agent 16b, to calculate the reward data.

The learning machine 16 has the first agent 16a, the second agent 16b and an adjustment unit 16c as illustrated in FIG. 3. The first agent 16a and the second agent 16b are agents having different systems. The first agent 16a is a model more complicated than the second agent 16b. The first agent 16a is a model more expressive than the second agent 16b. In other words, the first agent 16a can achieve more optimal parameter adjustment by reinforcement learning as compared with the second agent 16b.

Though the search range for a molding condition obtained by the first agent 16a is wider than that of the second agent 16b, abnormal operation by the molding machine 2 may cause unexpected disadvantage to the molding machine 2 and the operator. On the other hand, though the second agent 16b has a narrower search range than the first agent 16a, it has a low possibility of abnormal operation of the molding machine 2.

The first agent 16a includes a reinforcement learning model with a deep neural network such as DQN, A3C, D4PG or the like, or a model-based reinforcement learning model such as PlaNet, SLAC or the like.

In the case of the reinforcement learning model with a deep neural network, the first agent 16a has DeepQNetwork (DQN) and decides, based on a state s of the molding machine 2 indicated by the observation data, an action a1 in correspondence with the state s of the molding machine 2. The DQN is a neural network model that outputs values of multiple actions a1 when the state s indicated by the observation data is input. The multiple actions a1 correspond to the molding conditions. The action a1 of a high action value represents an appropriate molding condition to be set for the molding machine 2. The action a1 causes the molding machine 2 to transition to another state. After the transition, the first agent 16a receives a reward calculated by the reward calculation unit 15b and trains the first agent 16a such that the return, that is, the accumulation of rewards is maximum.

More specifically, the DQN has an input layer, an intermediate layer and an output layer. The input layer has multiple nodes to which states s, that is, observation data are input. The output layer has multiple nodes that respectively correspond to multiple actions a1 and output values Q (s, a1) of the actions a1 in the input states s. The actions a1 may correspond to parameter values related to the molding conditions or may be change amounts. Here, the action a1 is assumed to be a parameter value. Various weight coefficients characterizing the DQN are adjusted by the value Q expressed in the following equation (1) as training data based on the state s, the action a1 and the reward r obtained from the action to allow the DQN of the first agent 16a to perform reinforcement learning.

Q(s,a1)←Q(s,a1)+α(r+γmax Q(s_next,a1_next)−Q(s,a1)) (1)
where
s: state
a1: action
α: learning rate
r: reward
γ: discount rate
maxQ (s_next, a1_next): maximum value out of the Q values for the next possible action

In the case of the model-based reinforcement learning model, the first agent 16a has a state expression map and decides a parameter (action 1) by using the state expression map as a guide for deciding an action. The first agent 16a uses the state expression map to decide the parameter (action a1) corresponding to the state s based on the state s of the molding machine 2 as indicated by the observation data. For example, the state expression map is a model that outputs, if the observation data (state s) and the parameter (action a1) are input, a reward r for taking the parameter (action a1) in this state s and a state transition probability (certainty rate) Pt to the next status s′. The reward r may be information indicating whether or not a molded product obtained when a certain parameter (action a) is set in the state s is normal. The action a1 is a parameter that is to be set to the molding machine 2 in this state. The action a1 causes the molding machine 2 to transition to another state. After the state transition, the first agent 16a receives a reward calculated by the reward calculation unit 15b and updates the state expression map.

The second agent 16b has a functional model or a functional approximator that represents a relationship between observation data and a parameter related to a molding condition. The functional model can be defined by interpretable domain knowledge, for example. The functional model is achieved by approximation using a polynomial function, an exponential function, a logarithmic function, a trigonometrical function or the like and by approximation using a probability distribution such as a uniform distribution, a multinomial distribution, Gaussian distribution, Gaussian Mixture Model (GGM) or the like. The functional model may be a linear function or a nonlinear function. The distribution may be specified by a histogram or kernel density estimation. The second agent 16b may be constructed using a functional approximator such as a neighbor method, a decision tree, a shallow neural network or the like.

FIG. 4 is a conceptual diagram illustrating a functional model and a search range. The function model of the second agent 16b is a function that returns an optimal probability by taking, for example, observation data (state s) and a parameter (action a2) related to a molding condition as inputs. The optimal probability is a probability where the action a2 in that state s is optimal, and is calculated from a defect degree or a reward. The horizontal axis of the graph in FIG. 4 indicates one parameter (when the observation data and the other parameters are fixed) for the molding condition while the vertical axis indicates the optimal probability of the state and the parameter indicated by the observation data. The functional model of the second agent 16b is provided with observation data and the reward to thereby calculate a parameter range that is a candidate for an optimal molding condition as a search range. The method of setting the search range is a predetermined confidence interval, for example, 95% confidence interval, though not limited to a particular one. If the graph of the optimal probability for one parameter (when the observation data and the other parameters are fixed) can be empirically defined as the Gaussian distribution, the confidence interval represented by 2 σ may be used as a search range for the one parameter.

In the case where the second agent 16b is constructed by a functional approximator as well, the search range can be set in the same way.

By random activation of the second agent 16 within the search range instead of the first agent 16a, the learning by the second agent 16 may be performed before the learning by the first agent 16a. By training only the second agent 16b in advance, the first agent 16a can be trained more safely and extensively.

The adjustment unit 16c adjusts based on the search range calculated by the second agent 16b the parameter (action a1) to be searched by the first agent 16a that is performing the reinforcement learning and outputs the adjusted parameter (action a).

The reinforcement learning method according to the first embodiment is described in detail below.

### [Reinforcement Learning Processing]

FIG. 5 is a flowchart illustrating a processing procedure performed by the processor 11. It is assumed that actual molding is performed while initial values of the parameters are set to the molding machine 2.

First, when the molding machine 2 executes molding, the measurement unit 3 measures the physical quantities related to the molding machine 2 and the molding product, and outputs physical quantity data measured and obtained to the control unit 15 (step S11).

The control unit 15 acquires the physical quantity data output from the measurement unit 3, generates observation data based on the acquired physical quantity data and outputs the generated observation data to the first agent 16a and the second agent 16b of the learning machine 16 (step S12).

The first agent 16a of the learning machine 16 acquires the observation data output from the observation unit 15a, calculates a parameter (action a1) for adjusting the parameter of the molding machine 2 (step S13), and outputs the calculated parameter (action a1) to the adjustment unit 16c (step S14). In operation (inference phase), the first agent 16a may select an optimal action a1 while, in training, the first agent 16a may decide an exploratory action a1 for performing reinforcement learning on the first agent 16a. Using an objective function whose numerical value decreases as the action value is higher or as the action a1 is unsearched and increases as the changed amount from the present molding condition is greater, the first agent 16a may select an action a1 having the smallest numerical value of the objective function.

The second agent 16b of the learning machine 16 acquires the observation data output from the observation unit 15a, calculates search range data indicating a search range of a parameter based on the observation data (step S15), and outputs the calculated search range data to the adjustment unit 16c (step S16).

The adjustment unit 16c of the learning machine 16 adjusts the parameter output from the first agent 16a so as to fall within the search range output from the second agent 16b (step S17). In other words, the adjustment unit 16c determines whether or not the parameter output from the first agent 16a falls within the search range output from the second agent 16b. If it is determined that the parameter falls out of the search range, the parameter is changed so as to fall within the search range. If it is determined that the parameter falls within the search range, the parameter output from the first agent 16a is adopted as it is.

The adjustment unit 16c outputs the adjusted parameter (action a) to the molding machine 2 (step S18).

The molding machine 2 adjusts the molding condition with the parameter and performs molding process according to the adjusted molding condition. The physical quantities of the operation of the molding machine 2 and the molded product are input to the measurement unit 3. The molding process may be repeated several times. When the molding machine 2 performs molding, the measurement unit 3 measures the physical quantities of the molding machine 2 and the molded product, and outputs the measured and obtained physical quantity data to the observation unit 15a of the control unit 15 (step S19).

The observation unit 15a of the control unit 15 acquires the physical quantity data output from the measurement unit 3, generates observation data based on the acquired physical quantity data and outputs the generated observation data to the first agent 16a and the second 16b of the learning machine 16 (step 20). The reward calculation unit 15b calculates reward data defined in accordance with the defect degree of the molded product based on the physical quantity data measured by the measurement unit 3 and outputs the calculated reward data to the learning machine 16 (step S21). Here, in the case where the action a1 output from the first agent 16a falls out of the search range, a minus reward is added in accordance with the deviation degree. That is, a larger minus reward (which has a larger absolute value) is added as the deviation degree increases for the action a1 output from the first agent 16a with respect to the search range output from the second agent 16b, to calculate the reward data.

The first agent 16a updates the model based on the observation data output from the observation unit 15a and the reward data output from the reward calculation unit 15b (step S22). In the case where the first agent 16a is DQN, the DQN is trained using the value represented by the above-mentioned equation (1) as teacher data.

The second agent 16b updates the model based on the observation data output from the observation unit 15a and the reward data output from the reward calculation unit 15b (step S23). The second agent 16b may update the functional model or the functional approximator by using, for example, the least-squares method, the maximum likelihood method, Bayesian estimation or the like.

According to the reinforcement learning method in the first embodiment thus configured, in the reinforcement learning of the learning machine 16 that adjusts the molding condition of the molding machine 2, the learning machine 16 can perform reinforcement learning by searching for an optimum molding condition safely without limiting the search range to a certain range.

More specifically, the learning machine 16 according to the first embodiment can perform reinforcement learning of an optimal molding condition using the first agent 16a having a higher capability of learning an optimum molding condition in comparison with the second agent 16b.

Furthermore, the search range of the molding condition obtained by the first agent 16a is wider than that of the second agent 16b, so that an abnormal operation of the molding machine 2 may cause unexpected disadvantage to the molding machine 2 and the operator. The adjustment unit 16c, however, can limit the search range to a safe search range presented by the second agent 16b on which the function and distribution defined by the prior knowledge of the user are reflected, which allows the first agent 16a to perform reinforcement learning by searching for an optimal molding condition safely.

Though the first embodiment described an example where a molding condition of the injection molding machine is adjusted by reinforcement learning, the applicable range of the present invention is not limited thereto. For example, by using the manufacture condition adjustment, the reinforcement learning method and the computer program 12a according to the present invention, the manufacture condition of the molding machine 2 such as an extruder or a film former as well as the other manufacturing devices may be adjusted by reinforcement learning.

Though the first embodiment described an example where the manufacture condition adjustment device 1 and the reinforcement learning device are included in the molding machine 2, the manufacture condition adjustment device 1 or the reinforcement learning device may be provided separately from the molding machine 2. Furthermore, the reinforcement learning method and the parameter adjustment processing may be executed on cloud computing.

Though an example where the learning machine 16 has two agents was described, it may have three or more agents. The first agent 16a and multiple second agents 16b, 16b having different functional models or different functional approximators may be provided. The adjustment unit 16c adjusts the parameter output from the first agent 16a that is performing reinforcement learning based on the search ranges calculated by the multiple second agents 16b, 16b . . . . Note that the adjustment unit 16c may calculate a search range by a logical sum or a logical product of the search ranges calculated by the multiple second agents 16b, 16b . . . and may adjust the parameter output by the first agent 16a so as to fall within the search range.

### SECOND EMBODIMENT

The molding machine system according to a second embodiment is different from that of the first embodiment in the method of adjusting the search range of a parameter. Since the other configurations of the molding machine system are similar to those of the molding machine system in the first embodiment, corresponding parts are designated by similar reference codes and detailed description thereof will not be made.

FIG. 6 is a flowchart illustrating a processing procedure for adjusting a search range according to the second embodiment. At step S17 in FIG. 5, the processor 11 performs the following processing. The processor 11 acquires a threshold for adjusting the search range (step S31). The threshold is a numerical value (%), σ interval or the like that defines the confidence interval as illustrated in FIG. 4, for example. The control unit 15 or the adjustment unit 16c acquires the threshold via the operation unit 13, for example. The operator can input the threshold by operating the operation unit 13 to adjust the tolerance of the search range.

The first agent 16a then calculates a parameter related to the molding condition based on the observation data (step S32). Next, the second agent 16b calculates a search range defined by the threshold acquired at step S31 (step S33).

Subsequently, the adjustment unit 16c determines whether or not the parameter calculated by the first agent 16a falls within the search range calculated at step S33 (step S34). If it is determined that the parameter falls outside the search range calculated at step S33 (step S34: NO), the adjustment unit 16c adjusts the parameter so as to fall within the search range (step S35). For example, the adjustment unit 16c changes the parameter to a value that falls within the search range and is the closest to the parameter calculated at step S32.

If it is determined that the parameter falls within the search range at step S34 (step S34: YES), or if the processing at step S35 is terminated, the adjustment unit 16c determines whether or not the parameter calculated at step S32 falls within a predetermined search range (step S36). The predetermined search range is a preset numerical range and is stored in the storage unit 12. The predetermined search range specifies the values that can be taken by the parameter, and the range outside the predetermined search range is a numerical range that is not settable.

If it is determined that the parameter falls within the predetermined search range (step S36: YES), the adjustment unit 16c performs the processing at step S18. If it is determined that the parameter falls outside the predetermined search range (step S36: NO), the adjustment unit 16c adjusts the parameter so as to fall within the predetermined search range (step S37). For example, the adjustment unit 16c changes the parameter to a value that falls within the search range calculated at step S33 and the predetermined search range and is the closest to the parameter calculated at step S32.

According to the reinforcement learning method of the second embodiment, the intensity of limiting the search range by the second agent 16b can freely be adjusted. In other words, it is possible to select or adjust whether reinforcement learning is performed on the first agent 16a by actively searching for a more optimal molding condition while allowing an abnormal operation of the molding machine 2 to a certain extent, or whether reinforcement learning is performed on the first agent 16a while prioritizing the normal operation of the molding machine 2.

Though the search range calculated by the second agent 16b may be an inappropriate range depending on a training result of the second agent 16b or the threshold for adjusting the search range, setting of a predetermined search range allows the learning machine 16 to perform reinforcement learning while searching for a molding condition safely.

### Modified Example

The second embodiment described an example where the intensity of limiting a search range by the second agent 16b is adjusted by mainly the operator setting the threshold, the adjustment unit 16c may automatically adjust the threshold. For example, if learning of the first agent 16a progresses and a reward of a predetermined value or higher is obtained at a predetermined ratio or higher, the adjustment unit 16c may change the threshold so as to expand the search range calculated by the second agent 16b. If, on the other hand, a reward less than a predetermined value is obtained at a predetermined ratio or higher, the adjustment unit 16c may change the threshold so as to narrow the search range calculated by the second agent 16b.

The threshold may be changed such that the search range calculated by the second agent 16b periodically varies. For example, the adjustment unit 16c may change the threshold one out of ten times so as to expand the search range, and may change the threshold nine out of ten times so as to narrow the search range with emphasis on safety.

Though the second embodiment described an example where the intensity of limiting a search range is adjusted by the second agent 16b, the adjustment unit 16c may release the limitation of the search range by the second agent 16b in response to an operation by the operator or in the case of a predetermined condition being satisfied. For example, if learning of the first agent 16a progresses and a reward of a predetermined value or higher is obtained at a predetermined ratio or higher, the adjustment unit 16c may release the limitation of the search range by the second agent 16b. Moreover, the adjustment unit 16c may release the limitation of the search range by the second agent 16b at a predetermined frequency.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1. A reinforcement learning method for a learning machine including
a first agent adjusting a manufacture condition of a manufacturing device based on observation data obtained by observing a state of the manufacturing device and
a second agent having a functional model or a functional approximator representing a relationship between the observation data and the manufacture condition in a different way from the first agent,
the reinforcement learning method comprising:
adjusting the manufacture condition searched by the first agent that is performing reinforcement learning, using the observation data and the functional model or the functional approximator of the second agent;
calculating reward data in accordance with a state of a product manufactured by the manufacturing device under the manufacture condition adjusted; and
performing reinforcement learning on the first agent and the second agent based on the observation data and the reward data calculated.

2. The reinforcement learning method according to claim 1, comprising:
calculating a search range of the manufacture condition using the observation data and the functional model or the functional approximator of the second agent, and
in a case where the manufacture condition searched by the first agent that is performing reinforcement learning falls out of the search range calculated, changing the manufacture condition searched to the manufacture condition falling within the search range.

3. The reinforcement learning method according to claim 2, comprising:
acquiring a threshold for calculating the search range of the manufacture condition using the observation data and the functional model or the functional approximator of the second agent, and
calculating the search range of the manufacture condition using the threshold acquired, the observation data and the functional model or the functional approximator of the second agent.

4. The reinforcement learning method according to claim 2, comprising, in a case where the manufacture condition searched by the first agent that is performing reinforcement learning falls out of a predetermined search range, changing the manufacture condition searched to the manufacture condition falling within the predetermined search range and the search range calculated.

5. The reinforcement learning method according to claim 1, comprising, in a case where the manufacture condition searched by the first agent is adjusted by the second agent, calculating the reward data by adding a minus reward in accordance with a deviation degree of the first agent from a search range.

6. The reinforcement learning method according to claim 1, wherein the manufacturing device is a molding machine.

7. The reinforcement learning method according to claim 6, wherein
the manufacturing device is an injection molding machine,
the manufacture condition includes an in-mold resin temperature, a nozzle temperature, a cylinder temperature, a hopper temperature, a mold clamping force, an injection speed, an injection acceleration, an injection peak pressure, an injection stroke, a cylinder-tip resin pressure, a reverse flow preventive ring seating state, a holding pressure switching pressure, a holding pressure switching speed, a holding pressure switching position, a holding pressure completion position, a cushion position, a metering back pressure, a metering torque, a metering completion position, a screw retreat speed, a cycle time, a mold closing time, an injection time, a pressure holding time, a metering time and a mold opening time, and
the reward data is data calculated based on observation data of the injection molding machine or a defect degree of a molded product manufactured by the injection molding machine.

8. A non-transitory computer readable recording medium storing a computer program causing a computer to perform reinforcement learning on a learning machine including
a first agent adjusting a manufacture condition of a manufacturing device based on observation data obtained by observing a state of the manufacturing device and
a second agent having a functional model or a functional approximator representing a relationship between the observation data and the manufacture condition in a different way from the first agent,
the computer program causing the computer to execute processing of:
adjusting the manufacture condition searched by the first agent that is performing reinforcement learning using the observation data and the functional model or the functional approximator of the second agent;
calculating reward data in accordance with a state of a product manufactured by the manufacturing device under the manufacture condition adjusted; and
performing reinforcement learning on the first agent and the second agent based on the observation data and the reward data calculated.

9. A reinforcement learning device performing reinforcement learning on a learning machine adjusting a manufacture condition of a manufacturing device based on observation data obtained by observing a state of the manufacturing device, wherein
the learning machine comprising
a first agent that adjusts the manufacture condition of the manufacturing device based on the observation data;
a second agent that has a functional model or a functional approximator representing a relationship between the observation data and the manufacture condition in a different way from the first agent;
an adjustment unit that adjusts the manufacture condition searched by the first agent that is performing reinforcement learning, using the observation data and the functional model or the functional approximator of the second agent; and
a reward calculation unit that calculates reward data in accordance with a state of a product manufactured by the manufacturing device under the manufacture condition adjusted,
the learning machine performing reinforcement learning on the first agent and the second agent based on the observation data and the reward data calculated by the reward calculation unit.

10. A molding machine comprising:
the reinforcement learning device according to claim 9, and
a manufacturing device operated using the manufacture condition adjusted by the first agent.
